(19) United States
(12) Patent Application Publication
(10) Pub. No.: US 2013/0167433 A1
(43) Pub. Date: Jul. 4, 2013

(54) SULFUR SOLVENT COMPOSITIONS, METHODS FOR REMOVING SULFUR DEPOSITS AND PROCESSES FOR MAKING SULFUR SOLVENT COMPOSITIONS

(71) Applicant: BRENNTAG CANADA INC., Toronto (CA)

(72) Inventors: Qiang Liu, Calgary (CA); Roger Dale Grey, Calgary (CA)

(21) Appl. No.: 13/721,207

(22) Filed: Dec. 20, 2012

(30) Foreign Application Priority Data
Dec. 30, 2011 (CA) 2762754

(51) Int. Cl. C09K 3/00

(52) U.S. Cl. CPC C09K 3/00
USPC 44/622; 252/364; 208/236; 585/860; 210/634

(57) ABSTRACT

Sulfur solvent compositions are provided that have relatively low toxicity, low and not unpleasant odor, and a substantial capacity for rapidly dissolving elemental sulfur from deposits even at low temperatures and in the presence of water. The compositions comprise a reaction menstruum prepared using an amine component and a ketone component in the presence of alkanol.

### FIELD OF THE INVENTION

This invention pertains to sulfur solvent compositions for use in removing elemental sulfur deposits in petroleum bearing formations, oil and gas wells, and piping and process equipment in the petroleum, refining, petrochemical and chemical industries; the use of such compositions in methods for removing such deposits and processes for making the sulfur solvent compositions. More particularly, this invention pertains to compositions prepared from amines and ketones.

### BACKGROUND

The problem of sulfur deposits occurring in sour natural gas wells and crude oil wells and in processing equipment has long been recognized. Numerous sulfur solvents have been proposed for the removal of sulfur deposits. These solvents contact the deposits to dissolve the sulfur to thereby enable it to be removed. Presently commercially available solvents include, but are not limited to dimethyl disulfide and bis-hexaethylene triamine.

To be commercially viable, sulfur solvents must possess acceptable sulfur removal properties and also be able to be used at the site without undue handling difficulties or health, safety and environmental issues. Moreover, the sulfur solvents have to be cost effective. Although current commercially-available products have acceptable sulfur removal performances, there is a need for improvement.

For instance, dimethyl disulfide is toxic and has a skunky odor. Dimethyl disulfide and secondary amine solvents become very viscous upon dissolving sulfur. The presence of water can materially reduce the effectiveness of dimethyl sulfide and secondary amine solvents. Moreover, in some field applications, the ambient temperature at the sulfur deposit is low. At temperatures below about 30° C., the effectiveness of many solvents to dissolve sulfur is greatly reduced.

Despite the need for improved sulfur solvents, significant hurdles must be overcome to achieve acceptable sulfur removal properties while still avoiding undue handling difficulties or health, safety and environmental issues and while having a sulfur solvent product that is cost competitive. Acceptable sulfur removal properties include the ability to quickly dissolve large amounts of sulfur per liter of sulfur solvent; the ability to have a low viscosity, sulfur laden solvent to facilitate removal of the sulfur from the site of the deposit; the ability to operate over a wide range of temperatures, especially at temperatures of 30° C. or lower while still providing a rapid dissolution of elemental sulfur in large amounts per liter of sulfur solvent. Further, the sulfur solvents need to be able to perform in the environment of the sulfur deposit, which for gas wells often include the presence of water. Advantageously, a sulfur solvent would possess low toxicity and be relatively odor-free to facilitate its use in the field.

### SUMMARY OF THE INVENTION

By this invention sulfur solvents are provided that can have relatively low toxicity, low and not unpleasant odor, and a substantial capacity for rapidly dissolving elemental sulfur from deposits even at low temperatures and in the presence of water. Moreover, the solvents, after dissolving sulfur, can have sufficiently low viscosities that removal of sulfur can readily be accomplished. The solvent compositions of this invention can be prepared from relatively inexpensive materials thereby providing economic attractiveness together with performance.

In accordance with invention, the sulfur solvent compositions comprise a reaction menstruum prepared using at least one primary or secondary amine having 1 to about 8 carbons, at least one ketone having from 2 to about 6 carbons and at least one lower alkanol having up to about 6 carbons. Advantageously, the sulfur solvents of this invention typically possess a greater sulfur up-take per gram than does the amine per gram under substantially the same conditions and are less adversely affected by the presence of water than the amine under substantially the same conditions. The preferred sulfur solvent compositions of this invention are particularly effective at low temperatures, say, below about 0° C., than the amine alone.

In further detail, the sulfur solvent compositions of this invention comprise a reaction menstruum, said menstruum being prepared from

a) an amine component comprising at least one amine represented by formula:

H—N—(R₁)R₂
wherein R₁ is hydrogen, alkyl or substituted alkyl and R₂ is alkyl or substituted alkyl having 1 to about 6 carbon atoms with the proviso that R₁ and R₂ together contain no more than 8 carbon atoms;
   b) a ketone component comprising at least one ketone represented by the formula:

R₃—C(O)—R₄
wherein R₃ and R₄ are the same or different and are alkyl and substituted alkyl moieties having 1 to about 6 carbon atoms with the proviso that R₁ and R₂ together contain no more than 8 carbon atoms; and
   c) an alkanol component comprising at least one alkanol represented by the formula:

R₅OH
wherein R₅ is alkyl or substituted alkyl of 1 to 6 carbon atoms,
   wherein the mole ratio of amine moiety to ketone is (15:1 to 20:1 and the alkanol component is present in an amount of at least about 1 mass percent of the reaction menstruum.

In the aspect of this invention pertaining to processes for making a sulfur solvent composition, the processes comprising:

a) admixing
i. an amine component comprising at least one amine represented by formula:

H—N—(R₁)R₂
wherein R₁ is hydrogen, alkyl or substituted alkyl and R₂ is alkyl or substituted alkyl having 1 to about 6 carbon atoms with the proviso that R₁ and R₂ together contain no more than 8 carbon atoms;
ii. a ketone component comprising at least one ketone represented by the formula:

R₃—C(O)—R₄
wherein R₃ and R₄ are the same or different and are alkyl and substituted alkyl moieties having 1 to about 6 carbon atoms with the proviso that R₁ and R₂ together contain no more than 8 carbon atoms; and
iii. an alkanol component comprising at least one alkanol represented by the formula:

R₅OH
wherein R₅ is alkyl or substituted alkyl of 1 to 6 carbon atoms,
   wherein the mole ratio of amine moiety to ketone is 0.5:1 to 20:1 and the alkanol component is present in an amount of at least about 1 mass percent of the reaction menstruum to form a reaction menstruum; and
   b) incorporating the reaction menstruum in a sulfur solvent composition.

The sulfur solvent composition may consist of the reaction menstruum and thus no action is required under step b. Step b, however, may include the addition of one or more of another reaction menstruum, additional amine component, additional alkanol component, and one or more adjuvants.

Another aspect of this invention pertains to methods for removing sulfur deposits using the sulfur solvent compositions of this invention by contacting the sulfur deposit with the solvent composition.

### DETAILED DISCUSSION

For purposes herein and for facilitating understanding of the invention, the following definitions shall be applied except where otherwise explicitly stated or evident from the content.

Sulfur up-take is the amount of sulfur removed by a sulfur solvent and is reported in gams of sulfur per 100 grams of sulfur solvent. In laboratory evaluations, the sulfur up-take is determined based upon the amount of elemental sulfur initially present and the remaining sulfur after treatment with the sulfur solvent. Thus the sulfur up-take (SU) is 100 times the quotient of the subtrahend of the sulfur initially provided in grams (Sᵢ) less the residual, undissolved sulfur in grams (Sᵣ) divided by the solvent mass in grams (Sol):

SU=100×[(Sᵢ−Sᵣ)/Sol].

The sulfur solvent may be used and evaluated over a wide range of conditions. For purposes herein, Standard Conditions is a selected, specific test procedure for evaluating the performance of a sulfur solvent and is as follows: Approximately 5 grams of powdered (average particle size less than about 0.07 millimeter), elemental sulfur (Sᵢ) are placed in 30 milliter glass bottle. Approximately grams of liquid (Sol) comprising sulfur solvent are added and the bottle is capped. The bottle is hand shaken ten times and then placed in a water bath at either 80° C. or −15° C. for one hour. Upon completion of the specified duration of time in the bath, the bottle is immediately removed and the contents filtered using 0.45 micron filter paper and a vacuum pump. The bottle is then rinsed with methanol to remove any remaining undissolved sulfur and the methanol rinse is poured into the filter. The solids retained on the filter paper are dried at 60° C. and weighed to determine the residual sulfur (Sᵣ). Where the 10 grams of liquid (Sol) consist only of the sulfur solvent, the Standard Conditions are termed Water-free Standard Conditions. Where the 10 grams of liquid (Sol) consist only of 8 grams of the sulfur solvent and 2 grams of deionized water are added to the sulfur prior to the addition of the sulfur solvent, the Standard Conditions are termed Defined Water Standard Conditions.

An amine moiety for purposes herein is a primary or secondary amine and not a tertiary or quaternary amine group. The each of the amine moieties in an amine compound are used in determining the mole ratio of amine moiety to ketone. Thus, a 1:1 mole ratio of amine compound to ketone for ethylamine would result in a mole ratio of amine moiety to ketone of 1:1; for ethylenediamine, 2:1; and for diethylentriamine, 3:1.

Reaction menstruum means a liquid medium that may or may not contain reaction product of two or more reactive components used to make the reaction menstruum. Where the reaction menstruum contains reaction product, the reaction product may be a final or intermediate reaction product.

The sulfur solvent of this invention is a reaction menstruum prepared by admixing at least one primary or secondary amine with at least one ketone and at least one alkanol. The primary and secondary amines can be represented by the formula:

H—N—(R₁)R₂

wherein R₁ is hydrogen, alkyl or substituted alkyl and R₂ is alkyl or substituted alkyl. The foregoing formula is intended to encompass amines where R₁ and R₂ form an alicyclic structure such as morpholine. The alkyl and substituted alkyl moieties contain 1 to about 6, preferably 2 to 4, carbon atoms with the proviso that R₁ and R₂ together contain no more than 8 carbon atoms, and preferably no more than about 6 carbon atoms and no more than about 6 total carbon and oxygen atoms. The substituted alkyl moieties may be substituted with one or more of hydroxyl, amino, thiol, alkoxy, and alkylsulfide. Primary amines are generally preferred. Advantageous amines are those substituted with a hydroxyl group. Representative amines include, but are not limited to, methylamine, dimethylamine, ethylamine, diethylamine, monoethanolamine, cysteamine, diethanolamine, diethylenetriamine, triethylenetetraamine, 1 aminopropane, 2-aminopropane, propanolamine, dipropylamine, propylenediamine, propanediamine, dipropanolamine, 1-aminobutane, 2-aminobutane, butylaminoethanol, and morpholine. Amines with less steric hindrance generally provide sulfur solvent compositions having better performance properties. Preferred amines are ethylamine, diethylamine, monoethanolamine, propanolamine, diethyl enetriamine, triethylenetetraamine, 1 aminopropane, 2-aminopropane, propanolamine, I aminobutane, 2-aminobutane, and butylaminoethanol.

The ketone can be represented by the formula:

R₃—C(O)—R₄

wherein R₃ and R₄ are the same or different and are alkyl and substituted alkyl moieties containing 1 to about 6, preferably 2 to 4, carbon atoms with the proviso that R₁ and R₂ together contain no more than 8 carbon atoms. The substituted alkyl moieties may be substituted with one or more of hydroxyl, amino, thiol, alkoxy, and alkylsulfide. Representative ketones include, but are not limited to acetone, methyl ethyl ketone, diethyl ketone, methyl n-propyl ketone, methyl i-propyl ketone, ethyl n-propyl ketone, ethyl i-propyl ketone, methyl n-butyl ketone, methyl i-butyl ketone, ethyl n-butyl ketone, ethyl i-butyl ketone, and 3-hydroxy-2-butanone. Preferred ketones include acetone, methyl ethyl ketone and methyl isobutyl ketone.

The alkanols may be represented by the formula:

R₅OH

wherein R₅ is alkyl or substituted alkyl of 1 to 6 carbon atoms. The substituted alkyl moieties may be substituted with one or more of hydroxyl, thiol, alkoxy, and halo groups. Representative alkanols include, but are not limited to methanol, ethanol, ethylene glycol, 2-chloroethanol, 2-mercaptoethanol, 2-methoxyethanol, ethoxyethanol, n-propanol, i-propanol, 1,2-propylene glycol, 1,3-propanediol, n-butanol, i-butanol, 1,4-butanediol, 1,2-butanediol, n-pentanol, 2-penatanol, 3-pentanol, 3-methyl-1-butanol, 2-methyl-1-butanol, 3-methyl-2 butanol, 2-methyl-2-butanol, cyclopentanol, n-hexanol, 2-hexanol, 3-hexanol, 2,3-dimethyl-1-butanol and cyclohexanol.

The sulfur solvents of this invention have a mole ratio of total amine moieties to ketone in the range of about 0.5:1 to 20:1, preferably about 0.75:1 to 10:1, and sometimes between about 0.9:1 to 5:1. Most frequently, the mole ratio of amine moieties to ketone is at least 1:1, and higher ratios often enhance performance of the sulfur solvent composition. In general, at mole ratios of total amine moieties to ketone below about 0.5:1, and sometimes below about 0.75:1 or 0.9:1, the sulfur up-take of the solvent is adversely affected. While not wishing to be limited by theory, the lower mole ratios may result in the presence of free ketone that may reduce the sulfur up-take capacity. Higher ratios sometimes do not result in as significant a decrease in performance as do lower ratios. However, the ratios are preferably not so high that the performance of the sulfur solvent composition is adversely affected. Adverse effects include a reduction in the sulfur up-take, a formation of a solid or highly viscous solvent containing the dissolved sulfur and reduced tolerance to the presence of water. Often the performance of the sulfur solvent composition and its tolerance to water are maximized at ratios between about 1.2:1 to 15:1. The optimal mole ratios, however, will depend upon the type of amine and ketone used. Often amines containing two primary amine groups such as ethylenediamine and diethylenetriamine provide more advantageous sulfur solvent compositions at lower mole ratios of amine moiety to ketone.

Sulfur solvent compositions containing primary amine groups tend to provide greater sulfur up-take than do substantially similar compositions but which contain a secondary amine rather than the primary amine. Accordingly, these sulfur solvent compositions are generally preferred especially for the removal of sulfur deposits at lower temperatures. Indeed, highly active amines such as ethylenediamine and diethylenetriamine may be used to make sulfur solvent compositions that form solid or highly viscous sulfur-laden solvents at higher temperatures (say, above about 10° C. or 20° C.), but at lower temperatures (say, below about 10° C. and sometimes below about 0° C.) or in the presence of water, provide flowable, sulfur-laden solvents with effective removal of sulfur from the deposits. Accordingly, the sulfur solvent compositions can be tailored for given conditions such as temperature and the presence of water at the point of the sulfur deposit to be removed.

The reaction menstruum may be prepared in any convenient manner by the addition of the amine component, the ketone component and the alkanol component. Each component may comprise one or more chemical compounds. The amount of each component may correspond to that in the sulfur solvent composition or the reaction menstruum may be used as a portion of the sulfur solvent composition. Accordingly, the relative amounts of the components and the compositions of the components can differ between the reaction menstruum and the sulfur solvent composition. Moreover, in accordance with this invention, two or more reaction menstrua may be prepared and then admixed before, during or after at least a portion of the amine component and the ketone component have reacted. Preferably the reaction menstruum contains less than about 20, more preferably less than about 10, mass percent water, and most preferably the reaction menstruum is substantially anhydrous prior to the completion of the reaction between the amine and ketone.

The presence of alkanol enhances the rate of reaction between an amine and a ketone. Without intending to be limited by theory, for purposes herein the activity of the alkanol will be characterized as catalytic. The amount of alkanol provided to the reaction menstruum is preferably at least sufficient to increase the rate of reaction between the amine component and the ketone component and is often used in an amount sufficient to provide a homogeneous solution in the reaction menstruum. Accordingly, the amount of alkanol in the reaction menstruum is often at least about 1, and sometimes between about 5 and 90, say, 5 and 70, mass percent of the reaction menstruum. More alkanol may be used but such amounts may exceed that sought in the sulfur solvent. Removal of excess alkanol can be done, if desired, e.g., by distillation or phase separation such as by solidification of the reaction product; however, in most uses of the sulfur solvent composition, high concentrations of alkanol do not adversely affect the performance.

Lower molecular weight alkanols such as methanol and ethanol tend to have higher catalytic activity than do the higher molecular weight alkanols such as isopropanol. Where a lower molecular weight alkanol is used in the reaction menstruum for its beneficial catalytic activity, in some instances it may be desired to also incorporate into the reaction menstruum or the sulfur solvent composition a higher molecular weight alkanol. The higher molecular weight alkanols can assist in providing a homogenous reaction menstruum where one of the amine component or ketone component would otherwise have limited solubility in the reaction menstruum. Moreover, a higher molecular weight alkanol can be beneficial in the sulfur solvent composition where heavy hydrocarbons are present in the region of the sulfur deposit being treated.

The reaction between the amine component and the ketone component may occur prior to or during the use of the sulfur solvent to remove sulfur deposits. The reaction conditions will depend, in part, upon the reactivities of the amine and ketone used and the type and amount of alkanol present. In many instances, primary amines are more reactive than secondary amines and higher molecular weight amine components and higher molecular weight ketone components tend to react more slowly. The reaction may be conducted at any suitable pressure and temperature. Subatmospheric, atmospheric and superatmospheric pressures may be used, e.g., from about 0.1 to 50,000 kPa absolute. Temperatures are often from about −20° C. to the boiling point under the conditions of the reaction of the lowest boiling component. Generally temperatures in the range of about −15° C. to 150° C., say, about −10° C. to 80° C., are used. The duration of the reaction can vary widely depending upon the components and conditions of the reaction, for instance from about 0.01 to 50, say, 0.02 to 20, hours.

The sulfur solvent composition can be prepared and shipped to the site for use, or one or more components can be added at the site to complete the preparation of the composition. It is not essential that a portion or all of the reaction between the amine component and the ketone component occur prior to contacting the sulfur deposit to be removed. For instance, it is within the broad aspects of this invention that the sulfur deposit is contacted with one or two of the amine component, the ketone component and the alkanol component and then contacted with the remaining one or two components. Preferably, at least a portion of the reaction between the amine component and the ketone component has occurred prior to contacting the sulfur deposit, and most preferably, the reaction between the amine component and the ketone component is substantially completed prior to contacting the sulfur deposit.

The sulfur solvent composition of this invention may consist essentially of the reaction menstruum or additional components may be added to provide the sulfur solvent composition. Preferably the sulfur solvent composition comprises between about 60 and 100, say, between about 70 and 100, mass percent of the reaction menstruum. The additional components can include another reaction menstruum, additional unreacted amine component, additional unreacted ketone component, additional alkanol component, and other adjuvant to facilitate flow of dissolved sulfur from the deposit being treated. These other adjuvants include surfactants such as anionic, non-ionic and cationic surfactants; aliphatic and aromatic hydrocarbons of I to about 20, preferably 4 to 12, carbon atoms; aliphatic ethers of 2 to 8 carbons; and the like. The preferred sulfur solvent compositions of this invention have a mass ratio of alkanol component to amine component and a mole ratio of amine component to ketone component sufficient to provide at least one of (i) a sulfur up-take under Standard Conditions at 80° C. of at least 10, more preferably at least about 25, grams of sulfur per 100 grams of sulfur solvent composition and (ii) a sulfur up-take under Standard Conditions at −15° C. of at least 1 gram of sulfur per 100 grams of sulfur solvent. The sulfur solvent compositions of this invention are less sensitive to the presence of water during sulfur removal than are similar sulfur solvent compositions not containing the ketone component. The preferred sulfur solvent compositions of this invention have a mass ratio of alkanol component to amine component and have a mole ratio of amine component to ketone component sufficient to provide a higher ratio of sulfur up-take under Defined Water Standard Conditions (at either or both −15° C. and 80° C.) to sulfur take-up under Standard Conditions at that temperature than that ratio for a sulfur solvent composition that is prepared from the same components but not including the ketone component (maintaining a constant amine to alkanol weight ratio) (“Reference Solvent”). Thus, the sulfur dissolving properties of the reaction product of the amine component and ketone component is less affected by the presence of water than is the unreacted amine component.

Often the sulfur solvent compositions of this invention can be characterized by the following (based upon components added without factoring in any reaction product):

| | Grams per 100 grams of | Preferred, grams per 100 |
|---|---|---|
| Component | sulfur solvent | grams of sulfur solvent |
| Amine Component | 5 to 80 | 15 to 70 |
| Ketone Component* | 2 to 50 | 3 to 40 |
| Alkanol Component | 10 to 90 | 20 to 70 |
| Other Adjuvants | 0 to 40 | 0 to 30 |

provided that the mole ratio of amine component to ketone component is no less than 0.5:1, preferably no less than 0.75:1.

Where the alkanol component of the sulfur solvent compositions of this invention comprises at least two alkanols, one of which is methanol or ethanol or both, and the other of which is isopropanol or isobutanol, preferably the mole ratio of the lighter alkanols to the heavier alkanols is from about 0.1:1 to 20:1, say, 5:1 to 15:1.

The sulfur solvent compositions of this invention are attractive in that they have a high capacity for sulfur even at low temperatures and have tolerance for the presence of water. Moreover, the sulfur solvent compositions promote the flow ability of the fluid at the sulfur removal site thereby facilitating transport of the dissolved sulfur from the treatment site and the flow of sulfur solvent composition to the sulfur deposit.

The sulfur deposits to be removed by the solvent compositions of this invention may be formed in sour oil and gas wells, formations and transport lines and may be formed in refining, petrochemical and chemical process operations, mining, geothermal, sewage handling and treatment, and thermal processing of coal and bitumen where sulfur or elemental sulfur generating compounds are present. The ambient temperature and pressure at the point of the sulfur deposit will depend upon the situation. For instance, the deposit may be located in a high temperature, high pressure well. Alternatively, it may be located in processing equipment or a well having much lower pressure and temperature. As the sulfur solvent compositions of this invention operate over a wide range of temperatures, the sulfur removal may be conducted at ambient temperatures at the site of the deposit. Often the temperature is between about −20° C. to 150° C. or more, and preferably the temperature is in the range of about −15° C. to 120° C. Pressures can range from subatmospheric to over 50,000 kPa. Moreover, ambient conditions can include the presence of water and hydrocarbons.

Often the sulfur solvent composition is intermittently or continuously passed into contact with the sulfur deposit to provide a flow. Spent sulfur removal solvent is withdrawn continuously, intermittently or periodically. The contact is continued until the sulfur deposit has been reduce to a desired level or eliminated. At lower temperatures, it is generally preferred to use longer contact times. If desired, sulfur values can be recovered from the spent solvent in any suitable manner, for instance, as elemental sulfur or a sulfur compound such as hydrogen sulfide.

### EXAMPLES

The following examples are for purposes of facilitating illustration of the invention and are not in limitation thereof. All parts and percentages are by mass unless otherwise stated or clear from the context.

### Examples 1 to 60

The following general procedure is used. Master batches of sulfur solvent composition are prepared by admixing an amine component, a ketone component and an alkanol component in a glass bottle at ambient temperature (about 22° C.) and turning the bottle upside down to assure a uniform distribution of the components. Any heat of reaction is allowed to dissipate by retaining the master batch at room temperature prior to performance evaluation. The performance of the sulfur solvent composition is evaluated by placing a specified amount of powdered (average particle size less than about 0.07 millimeter), elemental sulfur in 30 milliliter glass bottle and then adding approximately 10 grams of an aliquot portion of the sulfur solvent composition contained in the master batch. Where water is added (unless otherwise stated), 8 grams of an aliquot portion of the sulfur solvent are added to the bottle and separately 2 grams of water are added to the milliliter bottle. The bottle is capped and placed in a water bath (if above ambient temperature) for a specified duration of time. Different mixing routines are used depending upon temperature. For elevated temperatures, where the sample is placed in a bath, the bottle is hand shaken three times at 10 minutes after being placed in the bath and, if the duration of the evaluation is greater than 20 minutes, at 20 minutes after being placed in the bath. At room temperature (22° C.) and lower temperatures, the bottle is only shaken ten times at the beginning and no further shaking occurs. The performance evaluations at −13° C. involve the bottle being placed into a freezer. For the test at −13° C., the elemental sulfur and sulfur solvent are placed in a freezer to reach temperature equilibrium before adding the solvent to the sulfur.

Upon completion of the specified duration of time, the bottle is immediately removed and the contents filtered using 0.45 micron filter paper and a vacuum pump. The bottle is then rinsed with methanol to remove any remaining undissolved sulfur and the methanol rinse is poured into the filter. The solids retained on the filter paper are dried at 60° C. and weighed to determine the residual sulfur.

The results are summarized in the following table. The amine component, ketone component and alkanol component are described by the compounds added to the master batch and the mass of each component is calculated from the mass of the aliquot portion of the master batch added to the 30 milliliter bottle for evaluation of the sulfur solvent properties. In the table, the comments section indicates the duration of the contact between the solvent composition and sulfur and whether or not water has been added. Unless otherwise stated in the comments section, 5 grams of sulfur are added to the 30 milliliter bottle for performance evaluation. In the table, MEA is monothanolamine, MEK is methyl ethyl ketone, MNBA is mono-n-butylamine, DE(OH)A is diethanolamine, DPA is dipropylamine, TEA is triethylamine, DETA is diethylentriamine, MIBK is methyl isobutyl ketone, EIRef is heavy reformate. Examples that are comparative have a C after the example number.

| | | | | | | | | S up-take, | |
|---|---|---|---|---|---|---|---|---|---|
| | | | | | | | S up-take | g/100 g | |
| Example | Amine | grams | Ketone | grams | Alkanol/Solvent | grams | Temp., ° C. | solvent | Comments |
| 1 | Diethylamine | 4.25 | Acetone | 1.25 | Methanol | 3.75 | 22 | 3.2 | 1 hour |
| | | | | | Isopropanol | 0.75 | | | |
| 2 | Diethylamine | 4.25 | Acetone | 1.25 | Methanol | 3.75 | 40 | 20 | 1 hour |
| | | | | | Isopropanol | 0.75 | | | |
| 3 | Diethylamine | 4.25 | Acetone | 1.25 | Methanol | 3.75 | 60 | 24 | 0.5 hour |
| | | | | | Isopropanol | 0.75 | | | |
| 4 | Diethylamine | 4.25 | Acetone | 1.25 | Methanol | 3.75 | 80 | 48 | 0.5 hour |
| | | | | | Isopropanol | 0.75 | | | |
| 5 | Diethylamine | 4.25 | Acetone | 1.25 | Methanol | 3.75 | 45 | 26.9 | 1 hour |
| | | | | | Isopropanol | 0.75 | | | |
| 6 | Diethylamine | 4.25 | Acetone | 1.25 | Methanol | 3.75 | 45 | 25 | 1 hour |
| | | | | | Isopropanol | 0.75 | | | |
| 7 | Diethylamine | 4.25 | Acetone | 1.25 | Methanol | 3.75 | 80 | 47.6 | 15 minutes |
| | | | | | Isopropanol | 0.75 | | | |
| 8 | Diethylamine | 3.4 | Acetone | 1 | Methanol | 3 | 80 | 19.8 | 2 grams of water |
| | | | | | Isopropanol | 0.6 | | | added, 15 minutes |
| 9 | Diethylamine | 3.4 | Acetone | 1 | Methanol | 3 | 80 | 19.4 | 2 grams of water |
| | | | | | Isopropanol | 0.6 | | | added, 15 minute |
| 10 | MEA | 5.5 | MEK | 1.8 | Isopropanol | 2.7 | 80 | 64 | 1 hour |
| 11 | MEA | 4.4 | MEK | 1.4 | Isopropanol | 2.2 | 80 | 52.8 | 2 grams of water |
| | | | | | | | | | added, 15 minutes |
| 12 | Diethylamine | 2.5 | Acetone | 2.5 | Methanol | 3 | 45 | 20.5 | 1 hour |
| | | | | | Xylene | 2 | | | |
| 13 C | Diethylamine | 10 | None | | None | | 22 | 1 | 1 hour |
| 14 C | MEA | 10 | None | | None | | 22 | 12.3 | 1 hour |
| 15 C | MEA | 10 | None | | None | | 60 | 30.5 | 0.5 hour |
| 16 C | MEA | 10 | None | | None | | 80 | 55.6 | 10 grams of sulfur |
| | | | | | | | | | used, 0.5 hour |
| 17 C | MEA | 7 | | | Isopropanol | 3 | 60 | 11.7 | 1 hour |
| 18 C | MEA | 8 | None | | None | | 80 | 19.8 | 2 grams of water |
| | | | | | | | | | added, 15 minutes |
| 19 C | MEA | 9 | None | | None | | 80 | 38 | 1 gram of water |
| | | | | | | | | | added, 6 grams of |
| | | | | | | | | | sulfur added, 0.5 |
| | | | | | | | | | hour |
| 20 C | MEA | 8 | None | | None | | 80 | 26.9 | 2 grams of water |
| | | | | | | | | | added, 6 grams of |
| | | | | | | | | | sulfur added, 0.5 |
| | | | | | | | | | hour |
| 21 | MEA | 8 | Acetone | 0.5 | Methanol | 1.5 | 80 | 59.4 | 6 grams of sulfur, 0.5 |
| | | | | | | | | | hour |
| 22 | MEA | 7 | Acetone | 0.6 | Methanol | 2.4 | 80 | 58.8 | 10 grams of sulfur, |
| | | | | | | | | | 0.5 hour |
| 23 | MEA | 7.5 | Acetone | 0.5 | Isopropanol | 2 | 80 | 58.3 | 10 grams of sulfur, |
| | | | | | | | | | 0.5 hour |
| 24 | MEA | 7.5 | MEK | 0.5 | Isopropanol | 2 | 80 | 63.5 | 10 grams of sulfur, |
| | | | | | | | | | 0.5 hour |
| 25 | MEA | 6 | MEK | 0.4 | Isopropanol | 1.6 | 80 | 45 | 2 grams of water |
| | | | | | | | | | added, 15 minutes |
| 26 | MEA | 4.4 | MEK | 0.7 | Isopropanol | 2.9 | 80 | 49 | 2 grams of water |
| | | | | | | | | | added, 15 minutes |
| 27 | MEA | 5.5 | MEK | 1.8 | Isopropanol | 2.7 | 80 | 52.8 | 15 minutes |
| 28 | MEA | 3.5 | MEK | 3.8 | Isopropanol | 2.7 | 22 | 28.7 | 1 hour |
| 29 | MEA | 1.1 | MEK | 6.2 | Isopropanol | 2.7 | 22 | 4.5 | 1 hour |
| 30 | Diethylamine | 5.1 | Acetone | 0.4 | Methanol | 3.8 | 45 | 19.6 | 1 hour |
| | | | | | Isopropanol | 0.7 | | | |
| 31 | Diethylamine | 3 | Acetone | 2.4 | Methanol | 3.8 | 45 | 21.1 | 1 hour |
| | | | | | Isopropanol | 0.7 | | | |
| 32 | DPA | 3.5 | Acetone | 1.8 | Methanol | 3.8 | 45 | 3.2 | 1 hour |
| | | | | | Isopropanol | 0.7 | | | |
| 33 | DE(OH)A | 5.5 | MEK | 2 | Isopropanol | 2.7 | 45 | 1 | 1 hour |
| 34 | MNBA | 3 | Acetone | 2.4 | Methanol | 3.8 | 45 | 29 | 1 hour |
| | | | | | Isopropanol | 0.7 | | | |
| 35 | MNBA | 2.8 | MEK | 2.7 | Methanol | 3.8 | 45 | 25 | 1 hour |
| | | | | | Isopropanol | 0.7 | | | |
| 36 C | MNBA | 10 | None | | None | | 22 | 45 | 50 minutes |
| 37 C | MNBA | 4.2 | None | | None | | 22 | 42 | 50 minutes |
| 38 | MNBA | 8 | None | | None | | 22 | 16.9 | 2 grams of water |
| | | | | | | | | | added, 50 minutes |
| 39 | MNBA | 3.9 | Acetone | 1.6 | Methanol | 3.8 | 22 | 93 | 50 minutes |
| | | | | | Isopropanol | 0.7 | | | |
| 40 | MNBA | 3.2 | Acetone | 1.3 | Methanol | 3 | 22 | 26.7 | 2 grams of water |
| | | | | | Isopropanol | 0.6 | | | added, 50 minutes |
| 41 C | DETA | 10 | None | | None | | 22 | | Sulfur up-take |
| | | | | | | | | | product is gunky, 50 |
| | | | | | | | | | minutes |
| 42 C | DETA | 8 | None | | None | | 22 | 52 | 2 grams of water |
| | | | | | | | | | added, 50 minutes |
| 43 | DETA | 4.3 | Acetone | 1.2 | Methanol | 3.8 | 22 | | Sulfur up-take |
| | | | | | Isopropanol | 0.7 | | | product hardened, 50 |
| | | | | | | | | | minutes |
| 44 | DETA | 3.4 | Acetone | 1.1 | Methanol | 3 | 22 | 26.7 | 2 grams of water |
| | | | | | Isopropanol | 0.6 | | | added, sulfur up-take |
| | | | | | | | | | product hardened, 50 |
| | | | | | | | | | minutes |
| 45 | DETA | 3.5 | Acetone | 2.0 | Methanol | 3.8 | 22 | | Sulfur up-take |
| | | | | | Isopropanol | 0.7 | | | product hardened, 50 |
| | | | | | | | | | minutes |
| 46 | DETA | 2.8 | Acetone | 1.6 | Methanol | 3 | 22 | 20.5 | 2 grams of water |
| | | | | | Isopropanol | 0.6 | | | added, 50 minutes |
| 47 C | DETA | 8 | None | | None | | 22 | slow | 2 grams of water |
| | | | | | | | | | mixed with DETA |
| | | | | | | | | | prior to adding, 50 |
| | | | | | | | | | minutes |
| 48 | DETA | 3.0 | Acetone | 3.3 | Methanol | 3.0 | 22 | | 1 hour, not hardened |
| | | | | | Isopropanol | 0.7 | | | but sticky |
| 49 | DETA | 2.3 | Acetone | 4.0 | Methanol | 3.0 | 22 | 32.7 | 1 hour |
| | | | | | Isopropanol | 0.7 | | | |
| 50 | DETA | 2.4 | Acetone | 2.6 | Methanol | 2.4 | 22 | 20.6 | 2 grams of water |
| | | | | | Isopropanol | 0.6 | | | added, 1 hour |
| 51 | DETA | 1.8 | Acetone | 3.2 | Methanol | 2.4 | 22 | 12.7 | 2 grams of water |
| | | | | | Isopropanol | 0.6 | | | added, 1 hour |
| 52 | DETA | 3.0 | Acetone | 3.3 | Methanol | 3.0 | −13 | 1.0 | 1 hour |
| | | | | | Isopropanol | 0.7 | | | |
| 53 | DETA | 2.3 | Acetone | 4.0 | Methanol | 3.0 | −13 | 1.2 | 1 hour |
| | | | | | Isopropanol | 0.7 | | | |
| 54 C | TEA | 3.5 | MEK | 2 | Methanol | 3.8 | 45 | 13 | 1 hour |
| | | | | | Isopropanol | 0.7 | | | |
| 55 | MEA | 2.8 | MIBK | 4.5 | Isopropanol | 2.7 | 22 | 17 | 1 hour |
| 56 | MEA | 5.5 | MEK | 1.8 | Isopropanol | 2.7 | −13 | 2 | 1 hour |
| 57 | MNBA | 4.8 | Acetone | 0.7 | Methanol | 3.8 | −13 | 2.3 | 1 hour |
| | | | | | Isopropanol | 0.7 | | | |
| 58 | MEA | 5.5 | MEK | 1.8 | Isopropanol | 2.7 | −13 | 19.9 | 6 hours, flowable |
| 59 | MNBA | 3.1 | Acetone | 2.4 | Methanol | 3.8 | −13 | 7.3 | 6 hours, very |
| | | | | | Isopropanol | 0.7 | | | flowable |
| 60 | DETA | 2.3 | Acetone | 4.0 | Methanol | 3.0 | −13 | 7.0 | 6 hours, very |
| | | | | | Isopropanol | 0.7 | | | flowable |

Examples 43 to 46 and 48 to 51 demonstrate the significant sulfur dissolving activity of diethylenetriamine in sulfur solvent compositions, and the examples further show that the use of a greater molar amount of ketone in these compositions beneficially moderates the activity of the solvent composition to provide flowable, sulfur-laden solvent compositions and provides enhanced water tolerance. These examples also show that more active solvent compositions may be inoperable at higher temperatures due to the formation of solid or very viscous sulfur laden solvents but are very advantageous at lower temperatures. Examples 58 to 60 demonstrate that at lower temperatures, the sulfur solvent compositions have significant sulfur dissolving capacity although the duration of time required to achieve sulfur dissolution is longer than that required at higher temperatures.

### Example 61

Sulfur solvent composition having the ratio of ingredients set forth in Example 1 is used to remove a sulfur deposit in a sour natural gas well. The well requires work to be done down hole through the production string. In inserting the tools to do the work, the tools could not pass through a restriction in the production string caused by a sulfur deposit. The well casing is at a pressure of about 7000 kPa absolute and the region of the well having the sulfur deposit is at a temperature of about 113° C. In addition to natural gas, some water, carbon dioxide, hydrogen sulfide and liquid petroleum are present. The well production string is about 7.3 centimeters in diameter. About 25 liters per minute of the solvent composition at a temperature of about 5° C. is pumped through a 1.25 centimeter inside diameter pipe to flush the sulfur deposit. The spent solvent composition containing dissolved sulfur remains readily flowable. After about 60 minutes of pumping the solvent composition, the sulfur deposit is sufficiently removed to continue passing the tools into the well.

### Example 62

Sulfur solvent composition having the ratio of ingredients set forth in Example 1 is used to remove a sulfur deposit in another sour natural gas well. In this well a sulfur deposit exists that restricts the production flow. The well production string is at a pressure of about 7000 kPa absolute and the region of the well having the sulfur deposit is at a temperature of about 113° C. In addition to natural gas, some water, nitrogen, hydrogen sulfide and liquid petroleum are present. The well production string is about 8.25 centimeters in diameter. About 25 liters per minute of the solvent composition at a temperature of about 5° C. is pumped through a 1.25 centimeter inside diameter pipe to flush past the sulfur deposit. Spent solvent is removed from the well along with regular production. The spent solvent composition containing dissolved sulfur remains readily flowable. After about 85 minutes of pumping the solvent composition, the sulfur deposit is sufficiently removed to restart recovery of natural gas from the well. The production flow returns to normal.

The embodiments of the invention in which an exclusive property or privilege is claimed are defined as follows:

1. A sulfur solvent composition comprising a reaction menstruum, said menstruum being prepared from
a) an amine component comprising at least one amine represented by formula:
H—N—(R₁)R₂
wherein R_{I} is hydrogen, alkyl or substituted alkyl and R₂ is alkyl or substituted alkyl having 1 to about 6 carbon atoms with the proviso that R₁ and R₂ together contain no more than 8 carbon atoms;
b) a ketone component comprising at least one ketone represented by the formula:
R₃—C(O)—R₄
wherein R₃ and R₄ are the same or different and are alkyl and substituted alkyl moieties having 1 to about 6 carbon atoms with the proviso that R₁ and R₂ together contain no more than 8 carbon atoms; and
c) an alkanol component comprising at least one alkanol represented by the formula:
R₅OH
wherein R₅ is alkyl or substituted alkyl of 1 to 6 carbon atoms,
wherein the mole ratio of amine moiety to ketone is 05:1 to 20:1 and the alkanol component is present in an amount of at least about 1 mass percent of the reaction menstruum.

2. The composition of claim 1 in which the reaction tnenstruum comprises between about 60 and 100 mass percent of the composition.

3. The composition of claim 2 wherein the amine component comprises at least one of ethylamine, diethylamine, monoethanolamine, diethylenetriamine, triethylenetetraamine, 1 aminopropane, 2-aminopropane, propanolamine, 1-aminobutane, 2-aminobutane, and butylaminoethanol.

4. The composition of claim 2 wherein the ketone component comprises at least one of acetone, methyl ethyl ketone and methyl isobutyl ketone.

5. The composition of claim 2 wherein the alkanol component comprises at least one of methanol, ethanol, ethylene glycol, 2-chloroethanol, 2-mercaptoethanol, 2-methoxyethanol, ethoxyethanol, n-propanol, i-propanol, 1,2-propylene glycol, 1,3-propanediol, n-butanol, i-butanol, 1,4-butanediol, and 1,2-butanediol.

6. The composition of claim 2 wherein the reaction menstruum contains the reaction product between the amine component and the ketone component.

7. The composition of claim 1 comprising, based upon components from which it is prepared:
between about 5 and 80 mass percent of amine component;
between about 2 and 50 mass percent of the ketone component with the proviso that the mole ratio of amine moiety to ketone is no less than about 0.5:1; and
between about 10 and 90 mass percent of alkanol component.

8. The composition of claim 7 which contains at least one adjuvant.

9. The composition of claim 8 wherein the at least one adjuvant is at least one of anionic, non-ionic and cationic surfactants; aliphatic and aromatic hydrocarbons of 1 to about 12 carbon atoms; aliphatic ethers of 2 to 8 carbons.

10. The composition of claim 9 wherein the at least one adjuvant comprises hydrocarbon of 4 to 12 carbon atoms.

11. The composition of claim 7 wherein the mole ratio of amine component to ketone in the composition is sufficient to provide a composition that under Standard Conditions has a sulfur up-take of at least 20 grams and a tolerance to water under Defined Water Standard Conditions greater than that of the amine component alone.

12. A process for making a sulfur solvent composition comprising:
a) admixing
i) an amine component comprising at least one amine represented by formula:
H—N—(R₁)R₂
wherein R₁ is hydrogen, alkyl or substituted alkyl and R₂ is alkyl or substituted alkyl having 1 to about 6 carbon atoms with the proviso that R₁ and R₂ together contain no more than 8 carbon atoms;
ii) a ketone component comprising at least one ketone represented by the formula:
R₃—C(O)—R₄
wherein R₃ and R₄ are the same or different and are alkyl and substituted alkyl moieties having 1 to about 6 carbon atoms with the proviso that R₁ and R₂ together contain no more than 8 carbon atoms; and
iii) an alkanol component comprising at least one alkanol represented by the formula:
R₅OH
wherein R₅ is alkyl or substituted alkyl of 1 to 6 carbon atoms,
wherein the mole ratio of amine moiety to ketone is 0.5:1 to 20:1 and the alkanol component is present in an amount of at least about 1 mass percent of the reaction menstruum to form a reaction menstruum; and
b) incorporating the reaction menstruum in a sulfur solvent composition.

13. The process of claim 12 wherein the olvent composition consists of the reaction menstruum.

14. The process of claim 12 wherein the reaction menstruum is subjected to reaction conditions to produce a reaction product.

15. The process of claim 14 wherein the reaction conditions comprise a temperature of between about −20° C. and 150° C.

16. The process of claim 15 wherein the reaction menstruum is subjected to reaction conditions prior to incorporating the reaction menstruum in a sulfur solvent composition.

17. The process of claim 16 wherein the solvent composition consists of the reaction menstruum.

18. The process of claim 12 wherein the amine component comprises at least one of ethylamine, diethylamine, monoethanolamine, diethylenetriamine, triethylenetetraamine, 1 aminopropane, 2-aminopropane, propanolamine, 1-aminobutane, 2-aminobutane, and butylaminoethanol.

19. The process of claim 18 wherein the ketone component comprises at least one of acetone, methyl ethyl ketone and methyl isobutyl ketone.

20. A method for removing sulfur from a sulfur deposit comprising contacting the sulfur deposit with a sulfur solvent composition of claim 1.

21. The method of claim 20 wherein the amine component and the mole ratio of amine moiety to ketone of the sulfur solvent composition is selected based upon at least one of the temperature of and the presence of water during the contacting.

22. The method of claim 21 wherein the contacting is at a temperature below about 0° C. and the reaction menstruum is prepared using a primary diamine.

23. The method of claim 21 wherein the contacting is in the presence of water and the reaction menstruum is prepared using a primary diamine.

24. The method of claim 20 wherein the reaction menstruum is prepared using monoethanolamine.

25. The method of claim 20 wherein the sulfur solvent composition comprises at least two reaction menstrua.
